(19) United States
(12) Patent Application Publication
(10) Pub. No.: US 2023/0241533 A1
(43) Pub. Date: Aug. 3, 2023

(54) GRAVITY SEPARATION OF SLURRIES

(71) Applicant: EXTRAKT PROCESS SOLUTIONS, LLC, Bowling Green, KY (US)

(72) Inventors: Paul C. PAINTER, Boalsburg, PA (US); Aron LUPINSKY, Boalsburg, PA (US); Christian KUJAWA, Bowling Green, KY (US)

(73) Assignee: EXTRAKT PROCESS SOLUTIONS, LLC, Bowling Green, KY (US)

(21) Appl. No.: 18/008,036

(22) PCT Filed: Jun. 3, 2021
(86) PCT No.: PCT/US21/35569

§ 371 Date: Dec. 2, 2022

Related U.S. Application Data
(60) Provisional application No. 63/034,613, filed on Jun. 4, 2020.

(51) Int. Cl. B01D 21/01; B01D 21/24

(52) U.S. Cl. CPC B01D 21/01; B01D 21/2427; B01D 21/06

(57) ABSTRACT

Processes of thickening slurries such as from metal and non-metal based ore processes are disclosed. The processes include treating a feed slurry in a thickener apparatus with an indifferent salt in sufficient quantity to increase efficiency of solids-liquid separation as compared to a feed slurry in the thickener apparatus without the added indifferent salt.

### CROSS-REFERENCE TO RELATED APPLICATION

This application claims the benefit of U.S. Provisional Application No. 63/034,613 filed 4 Jun. 2020, the entire disclosure of which is hereby incorporated by reference herein.

### TECHNICAL FIELD

The present disclosure relates to gravity separation of slurries, e.g., thickening and clarification of slurries, to concentrate solids and recover water. Such slurries can result from processing ore, such as metal ore and coal and can include either or both of product and tailings streams.

### BACKGROUND

Various mining and extraction processes rely heavily on water for transporting ore from mine sites to processing centers and in various metal or mineral extraction processes at the extraction plant.

The fraction of valuable components in many ore bodies is small and in many areas of the world declining. For example, the amount of copper in ores mined in Chile has declined from 1.29% in 2000 to 0.65% in 2016 (Source: Chilean Copper Commission, Cochilco). As a result of these factors, large and growing amounts of unwanted (gangue) materials are produced, usually in the form of a slurry of particulate matter in water called tailings. Safe storage of such tailings involves effective removal of water from the tailings.

Many mining operations are in water stressed areas of the world, such as the western United States, central Australia and the Atacama Desert in Chile. It is therefore desirable to recover and reuse water from the tailings stream. Reusing water from tailings further reduces the growth of tailings impoundments.

Some mining operations use thickeners to recover and reuse water from tailings. Thickeners can separate, at least in part, solids from liquid in large scale mining operations that generate tailings streams. The product of using a thickener with tailings is either or both of a higher density underflow slurry or a clean or clarified overflow liquor, e.g., clean or clarified water. Polymer flocculants, such as polyacrylamide, are typically used as thickeners for tailings. Such flocculants are combined with tailings in thickener or clarifier equipment, which typically includes a tank with feed lines for the tailings and flocculant and thickener rakes to sweep settled slurry.

There is a need to improve the performance of gravity separation of slurries to achieve both a high rate of separation of solids from liquor and an increased underflow slurry solids content.

### SUMMARY OF THE DISCLOSURE

Advantages of the present disclosure include processes to thicken and clarifying slurries in an apparatus with an increased efficiency of solids-liquid separation.

Additional advantages of the present disclosure include processes to thicken slurries with an increased efficiency in an amount of solids-liquid separation at a constant feed solids concentration and throughput or at a higher specific throughput rate at constant feed solids concentration and thickener separation performance, both of which translate to a smaller thickener apparatus requirement. Another advantage is a high uprise rate, e.g., greater than about 10 m/hr, for clarifying operations. Further advantages entail requiring less feed dilution and mixing to achieve acceptable flocculation which translates to a smaller thickener feedwell or elimination of the feed well in a thickener or clarifying apparatus.

These and other advantages are satisfied, at least in part, by a process of treating a feed slurry in a thickener apparatus with an indifferent salt to separate the feed slurry into an underflow slurry and an overflow liquid. Advantageously, the underflow slurry can contain most, if not all, of the solids from feed slurry and the overflow liquid can have little solids.

An increased efficiency of solids-liquid separation of least 10%, e.g., by at least 15%, 25%, 50%, can be achieved when a sufficient quantity of indifferent salt is used to treat the feed slurry in the thickener apparatus as compared to feed slurry in the thickener apparatus without the quantity of indifferent salt. The efficiency can be determined by an increased rate of sedimentation of solids, an increased rate of overflow liquid throughput, and/or an increased solids concentration of the underflow solids by at least 10%, e.g., by at least 15%, 25%, 50%, as compared to feed slurry in the thickener apparatus without the quantity of indifferent salt.

Advantageously, the process can include treating feed slurry with an indifferent salt or solution thereof and can optionally include combining at least one polymer flocculant or solution thereof with the feed slurry or indifferent salt or both. The slurry can optionally be treated in the thickener apparatus with the at least one polymer flocculant concurrent with or subsequent to treating the slurry with the indifferent salt. The process can further comprises removing underflow slurry and overflow liquid from a thickener tank after treating the slurry.

Embodiments of the processes include one or more of the following features individually or combined. For example, the slurry subject to treatment can result from processing metal ore such as copper ore or from a coal tailings. In some embodiments, the indifferent salt can have a solubility in water (a salt/water solubility) of at least about 5 g/100 g at 20° C., e.g., at least about 10 g/100 g at 20° C. In still further embodiments, the indifferent salt can have a monovalent cation and can include an alkali salt such as an alkali halide, an ammonium-based salt, a phosphate based salt, or a sulfate based salt or combinations thereof. In certain embodiments, the treated feed slurry can include the indifferent salt of at least 0.4 wt %, such as at least 0.5 wt %, 0.75 wt % and even as high as 2 wt % or higher as a concentration of the dissolved indifferent salt in the aqueous phase of the feed slurry. In some embodiments, the at least one polymer flocculant is a polyacrylamide or co-polymer thereof, such as nonionic polyacrylamides and copolymers thereof.

In various embodiments, treating feed slurry can include combining feed slurry with a solution including the indifferent salt and optionally the at least one polymer flocculant. In some embodiments, the feed slurry can include a stream of tailings, e.g., tailings from processing metal ore such as copper ore, which can be combined with a stream of a solution including the indifferent salt with or without the at least one polymer flocculant. Advantageously, the streams can be mixed inline and/or with the aid of an inline mixer prior to being fed in to the thickener apparatus or mixed in the feedwell of the thickener apparatus. In certain embodiments, treating a feed slurry can be carried out at ambient temperature, e.g., no more than about 2° C. to about 5° C. above ambient. In still further embodiments, treating a feed slurry includes using a solution of one or more indifferent salts sourced from a natural or existing source such as seawater or a body of hypersaline water or sourced from a brine waste stream.

In still further embodiments, the overflow liquid, e.g., clarified water, can be separated from treated slurry by a flow thereof out of the thickener apparatus such as a flow of overflow liquid over a lip of the thickener tank. Advantageously, the overflow liquid separated from the treated slurry includes the indifferent salt dissolved therein which was added to treat the feed slurry. The separated overflow liquid including the dissolved indifferent salt can be used to treat additional feed slurry in the thickener apparatus. For example, the indifferent salt dissolved in the recovered can be concentrated, e.g., by reverse osmosis, and combined with additional feed slurry to treat additional feed slurry.

Advantageously, the processes of the present disclosure can increase the rate of sedimentation of solids by at least 10%, e.g., by at least 15%, 25%, 50%, as compared to feed slurry in the thickener apparatus without the added indifferent salt. Alternatively or in combination, the processes of the present disclosure can increase overflow liquid throughput by at least 10%, e.g., by at least 15%, 25%, 50%, as compared to feed slurry in the thickener apparatus without the added indifferent salt. Alternatively, or in combination, the processes of the present disclosure can increase the percentage by mass of solids (solids concentration) (% m) of underflow slurry by about 10%, e.g., by at least 15%, 25%, 50%, as compared to feed slurry in the thickener apparatus without the added indifferent salt.

Thickener apparatuses that can be used in the process can include a feed system fluidly connected to a thickener tank (tank) wherein the tank has an exit port for underflow slurry and a port or lip for overflow liquid. The feed system can be fluidly connected to a source of slurry and can optionally include a feedwell having a chamber for receiving feed slurry. If included, the feedwell can be located in the center of the tank and can be used to mix feed slurry with indifferent salt and optionally polymer flocculant. The feedwell can evenly distribute treated feed slurry over a cross sectional area of the tank. Feed slurry and indifferent salt and optionally polymer flocculant can be combined prior to feeding to introducing the treated slurry to the tank or within an optional feedwell. The tank can also include a rotating rake assembly to sweep underflow slurry. The indifferent salt can at least in part be obtained from recovered overflow liquid. In some aspects, the tank and/or feedwell can optionally receive overflow liquid internally to dilute the slurry feed to improve flocculation and settling response for certain feed slurries.

Additional advantages of the present invention will become readily apparent to those skilled in this art from the following detailed description, wherein only the preferred embodiment of the invention is shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

Reference is made to the attached drawings, wherein elements having the same reference numeral designations represent similar elements throughout and wherein:

FIG. 1 is a schematic illustration of a thickener that can be used in practicing certain aspects of the present disclosure.

FIG. 2 is a plot of underflow solids concentration as function of solids loading rate when treating a feed slurry with a solution of an indifferent salt and polymer flocculant according to aspects of the present disclosure.

FIG. 3 is a plot of overflow solids concentration as a function of solids loading rate when treating a feed slurry with a solution of an indifferent salt and polymer flocculant according to aspects of the present disclosure.

FIG. 4 is a plot of overflow rise rate as a function of solids loading rate when treating a feed slurry with a solution of an indifferent salt and polymer flocculant according to aspects of the present disclosure.

### DETAILED DESCRIPTION OF THE DISCLOSURE

Thickening is a process where a slurry, i.e., a solid-aqueous liquid mixture, is separated to a dense underflow slurry containing most of the solids and an overflow of essentially clear aqueous liquid, e.g. clarified water or liquor in leaching processes. Clarification is a process where a low density slurry is separated to a clear overflow liquor. The focus of thickeners is to increase the settled solids whereas the focus of clarifiers is to produce a clear overflow liquor. The driving force for the separation of either process is gravitational, where the differences in phase densities drive the separation of the solids and aqueous liquid. In mining applications, thickening through sedimentation is applied to both the product and tailings streams to recover water. This water can be recycled in the process.

Tailings are typically produced when mining and processing ores such as metal-based ores, e.g., aluminum, copper, zinc, lead, gold, silver, molybdenum, lithium, iron etc., non-metal based ores, e.g., phosphate ore, nitrate ore, iodine ore, oil sands, etc. Tailings can also be produced when processing coal. For example, certain processes finely grind coal prior to combustion to more readily liberate pyrite (a sulfur based compound) and hence reduce sulfur emissions upon combustion of the ground coal. Such processes can produce fine coal particles as well as other fine mineral or mineral matter in an aqueous composition that are difficult to recapture and reuse.

The present disclosure relates to treating an incoming feed slurry (e.g., a solid-aqueous liquid mixture of either product or tailings material) in an apparatus, e.g., a thickener or clarifier apparatus, with an indifferent salt to separate solids in the feed slurry into, e.g., an underflow slurry and an overflow liquid. It was found that by adding indifferent salt in a sufficient quantity to a feed slurry, efficient aggregation of solid particles and efficient flocculation results. It was further found that this process is considerably more efficient than conventional coagulation methods in that flocculation can be carried out at higher feed solids concentrations, requires less mixing and is effective with minerals such as for example clays that traditionally have been refractory to solids-liquid separation. The flocculation is more efficient in capturing fine and ultra-fine particles, which results in a cleaner overflow liquid. As such the present disclosure is also applicable to clarifiers. The floccule aggregates formed are more robust and less prone to shear. Due to the efficient flocculation which can be achieved in the feed pipe to the thickener, the dependency on a feedwell is reduced, and in many cases the need for a feedwell is eliminated entirely. Thus, in an aspect of the present disclosure, a slurry can be treated with an indifferent salt to separate the feed slurry into an underflow slurry and an overflow liquid in a thickener or clarifier apparatus without a feedwell.

Advantageously, the process of the present disclosure results in an increased solids-liquid separation efficiency of at least 10% as compared to feed slurry in the thickener apparatus without the added indifferent salt. The comparison is done at constant feed solids concentration and throughput. Hence, the processes of the present disclosure can have as increased rate of sedimentation of solids, an increased overflow liquid throughput, and/or an increased percentage by mass of solids (solids concentration) (% m) of thickener underflow slurry as compared to feed slurry in the thickener apparatus without the added indifferent salt. Each of the rate of sedimentation of solids, overflow liquid throughput, percentage by mass of solids (solids concentration) (% m) of thickener underflow slurry can individually be increased by at least 10%, e.g., by at least 15%, 25%, 50%, 75%, 100%, 125% or higher, as compared to feed slurry in the thickener apparatus without the added indifferent salt. The reasons for the separation efficiency improvement lies in the robust nature of the formed floccule aggregates and their increased settling rate in the upper part of the thickener, as well as in the higher hydraulic conductivity and consequent higher dewatering rate of the solids bed in the lower part of the thickener, as well as the improved fines and ultra-fines capture when treating feed slurry with the indifferent salt.

In practicing aspects of the present process, thickening a slurry includes treating a feed slurry with an indifferent salt or solution thereof and can optionally include treating the feed slurry with at least one polymer flocculant or solution thereof. The feed slurry can be treated in the thickener apparatus with the at least one polymer flocculant concurrent with or subsequent to treating the feed slurry with the indifferent salt. The process can further comprises removing underflow slurry and overflow aqueous liquid from the sediment tank as two distinct streams.

The feed slurry can be introduced into the tank via an optional feedwell. The solids in the feed slurry settle under the pull of gravity separating from the aqueous liquid, forming a bed which can be pushed towards the exit port by rakes. Separated aqueous liquid, e.g., clarified water, exits through an overflow outlet on the tank. Settling performance and the final solids content of the settled solids (underflow slurry) is enhanced using indifferent salts of the present disclosure.

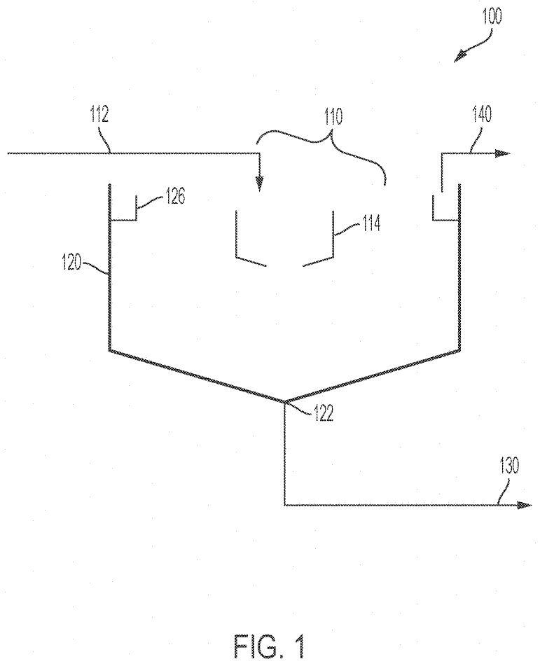

FIG. 1 schematically illustrates a thickener apparatus that can be used in the process. Thickener apparatus 100 can include a feed system (110) fluidly connected to a thickener tank (120) wherein the tank has an exit port (122) for underflow slurry (130) and port or lip (126) for overflow liquid (140). In some aspects, the tank and/or feedwell can optionally receive overflow liquid internally to dilute the slurry feed to improve flocculation and settling response for certain feed slurries. The feed system can be fluidly connected to a source of slurry (not shown for illustrative convenience) through a feed line (112) and can include a feedwell (114) having a chamber for receiving feed slurry. The feedwell (114) can be located in the center of the tank and can be used to mix feed slurry with indifferent salt and optionally polymer flocculant. The indifferent salt can at least in part be obtained from recovered overflow liquid. For example, the indifferent salt dissolved in the recovered overflow liquid and can be concentrated, e.g., by reverse osmosis, and combined with additional feed slurry to treat additional feed slurry in the thickener apparatus.

The feedwell can evenly distribute treated feed slurry over a cross sectional area of the tank. Feed slurry and indifferent salt and optionally polymer flocculant can be combined prior to feeding the slurry to the feedwell or within the feedwell itself. The tank can also include a rotating rake assembly to sweep underflow slurry (not shown for illustrative convenience). The feedwell can also include a sweeping rake to prevent solids build-up and/or to assist with mixing of the feed.

In conventional thickeners, feed slurry typically is diluted prior to thickening operations to a solids concentration of from 2% to 18% solids (by weight), e.g., from 3% to 18% solids (by weight). Dilution reduces reagent consumption through even more improved flocculation, improves free settling rates and thickener underflow solids concentration. However, an advantage of practicing aspects of the thickening process of the present disclosure is that dilution of the feed slurry can be minimized and even eliminated in the thickening operation. Hence in practicing aspects of the present the feed slurry can have a solids concentration of a multiple of 1.2 times, 1.5 times, 2 times, 2.5 times, 3 times or higher of a solids concentration when treating slurry with an indifferent salt compared to without the indifferent salt. For example, the feed slurry can have a solids concentration of greater than 10 wt % solids, such as greater than 15 wt % solids and greater than 20 wt %, 25 wt % and even higher than 30 wt % feed slurry solids when treating the feed slurry with an indifferent salt. For a conventional feed dilution requirement down to 3% to 5%, practicing aspects of the present disclosure can achieve the same efficiency with a dilution around 12% to 14%. For a conventional feed dilution requirement down to 15%, practicing aspects of the present disclosure can achieve the same efficiency with a dilution around 30% to 35%.

Further, the solids loading rate for a feed slurry treated according to processes of the present disclosure can be greater than conventional. Typical solids loading rate for an essentially clay-free feed is about 1.5 (metric tonne/hour)/meter squared ((t/h)/m²). Typical solids loading rate for course sand is about 2 (t/h)/m² and for typically feed slurries between about 0.025 and 1 (t/h)/m². Advantageously, the solids loading rate for a feed slurry to be treated with an indifferent salt and optionally polymer flocculant can be greater than 2 (t/h)/m², such at least about 2.5 (t/h)/m² and at least about 3, 3.5, 4, 4.5, 5 and 6 (t/h)/m².

In high-rate thickeners, solids contents in the underflow are of the order of 30% to 60% by weight, e.g., around 50% by weight, depending on the nature of the feed slurry and conditions of thickener operation (feed rate, etc.). Even higher solids concentrations in the underflow slurry can at times be obtained using high-density, high-compression or paste thickeners. These are taller than conventional thickeners to increase the self-consolidating weight on the solids in the formed bed. They also have steeper floor slopes to enhance the movement of settled slurry to the discharge point. The higher bed solids density of these thickeners relative to high rate thickeners greatly increases the rake torque, requiring a higher rake drive capability. In addition, as the solids density increases near the base of the thickener, hydraulic conductivity decreases, lowering the rate of water release. High density thickeners are more expensive than high rate thickeners and there is a trade-off between cost, the ability to pump thickener underflow and the amount of water recovered.

As used herein an indifferent salt is a salt that is highly soluble in the aqueous phase of the slurry, disassociating in to one or more cations and anions, and remains dissolved in the aqueous phase without precipitating from the slurry throughout the thickening process and remains dissolved in the overflow liquid. The disassociated cations or anions of the indifferent salt further do not chemically react to form coagulates or chemically react with components of the slurry such as polymer flocculant during the process or undergo oxidation or reduction reactions during the thickening process. Such indifferent salts are advantageous since they remain dissolved in the aqueous phase of the treated feed slurry and can be substantially recovered in the overflow liquid after treating the feed slurry and thus subsequently used to treat additional feed slurry.

Further, the indifferent salts are preferably not carboxylate salts since such organic acid salts tend to be more expensive than inorganic salts and can be deleterious to plant and/or animal life.

An indifferent salt preferably has a solubility in water of greater than 2 g of salt per 100 g of water (i.e., a salt/water solubility of 2 g/100 g) at 20° C. Preferably the indifferent salt has a water solubility of at least about 5 g/100 g at 20° C., e.g., at least about 10 g/100 g of salt/water at 20° C. Indifferent salts that are useful in practicing processes of the present disclosure include salts having a monovalent cation without multivalent cations, e.g., alkali salts such as an alkali halide salts such as sodium chloride, potassium chloride; also salts having monovalent cations without multivalent cations such as sodium and potassium nitrate, sodium and potassium phosphates, sodium and potassium sulfates, etc. are useful in practicing processes of the present disclosure. Other indifferent salts having monovalent cations useful in practicing processes of the present disclosure include ammonium based salts without multivalent cations such as ammonium chloride (NH₄Cl), ammonium bromide (NH₄Br), ammonium carbonate ((NH₄)₂CO₃), ammonium bicarbonate (NH₄HCO₃), ammonium nitrate (NH₄NO₃), ammonium sulfate ((NH₄)₂SO₄), ammonium hydrogen sulfate (NH₄HSO₄), ammonium dihydrogen phosphate (NH₄H₂PO₄), ammonium hydrogen phosphate ((NH₄)₂HPO₄), ammonium phosphate ((NH₄)₃PO₄), etc. Mixtures of such salts can also be used.

Certain ammonium based salts are useful for practicing the present disclosure since residual ammonium based salts on the concentrated solids can be beneficial to plant life. In fact, many of the ammonium based salts are useful as fertilizers, e.g., ammonium chloride, ammonium nitrate, ammonium sulfate, etc. Many of the monovalent cation sulfate and phosphate salts are also useful as fertilizers. In certain embodiments of the present disclosure, the indifferent salt or salts used in the processes of the present disclosure can preferably be non-toxic and beneficial to plant life to aid in environmental remediation and the restoration of mine sites.

Indifferent salts that can be used in practicing the present process can also include salts having multivalent cations. Such salts include, for example, divalent cation salts such as calcium and magnesium cation salts, such as calcium chloride (CaCl₂)), calcium bromide (CaBr₂), calcium nitrate (Ca(NO₃)₂), magnesium chloride (MgCl₂), magnesium bromide (MgBr₂), magnesium nitrate (Mg(NO₃)₂), magnesium sulfate (MgSO₄). However, experimentation with multivalent salts showed increased fouling of containers and formation of less cohesive consolidated materials as compared to indifferent salts having monovalent cations.

While coagulating salts and reactive salts can be used with the processes of the present disclosure, the processes of the present disclosure can be implemented without including a substantial amount of coagulating salts and/or reactive salts, e.g., less than 40 wt, 30 wt % 20 wt %, such as less than 10 wt %, if any at all, of such salts relative to the total amount, by weight, of salts (coagulating salts, reactive salts and indifferent salts) used to treat feed slurries.

Coagulating salts that are preferably not included in a substantial amount in treating feed slurries include aluminum coagulants such as alum, aluminum sulfate, (Al₂(SO₄)₃), aluminum chloride, and iron coagulants such as ferric chloride (FeCl₃), ferric sulfate (Fe₂(SO₄)₃), ferric citrate, ferrous sulfate (Fe(SO₄)), ferrous ammonium sulfate, lime (CaO), etc. Reactive salts that are preferably not included in a substantial amount in treating feed slurries include titanium salts, zinc salts, such as zinc chloride, zirconium salts such as zirconium acetate, zirconium oxychloride, ceric ammonium nitrate, etc.

When a sufficiently high concentration of the indifferent salt is included in treating a feed slurry, the indifferent salt can destabilize and consolidate solids in underflow slurry. Thickening and clarifying apparatus have relatively high mixing and allow for efficient mixing of the indifferent salt. Aspects of practicing the disclosure include a total dissolved indifferent salt concentration of the indifferent salt of at least of at least 0.4 wt %, such as at least 0.5 wt %, 0.75 wt % and preferably no less than about 0.5 wt %, 0.75 wt %, such as at least about 1 wt %, 1.5 wt %, 2 wt % and even at least about 2.5 wt % 3 wt %, 4 wt %, 5 wt %, etc. Determination of the concentration of the indifferent salt dissolved in the aqueous fraction includes the amount added together with any indifferent salt that may already be part of the aqueous fraction of the feed slurry prior to addition of indifferent salt to the feed slurry.

The indifferent salt(s) can be used to treat feed slurry of the present disclosure as a solid, e.g., combining the salt as a powder with the feed slurry. Alternatively, the salt can be in a solution to treat feed slurry, e.g., by combining an aqueous salt solution with feed slurry in the thickener apparatus. In some aspects of the present disclosure, an aqueous solution of the indifferent salt can be used having a concentration of no less than about 1 wt %, e.g., greater than about 2 wt %, 3 wt %, 5 wt %, 7 wt %, 10 wt %, 20 wt %, 30 wt % and even as great as a 40 wt % or as an aqueous salt slurry. The feed slurry and indifferent salt solution should be mixed at a ratio sufficient to destabilize and consolidate solids in the slurry.

In some embodiments of the present processes, it can be more advantageous to use a natural source of the indifferent salt or salts such as in a natural body of water including such salts in sufficiently high concentration such as at least about 2 wt % and even at least about 3 wt % or greater. For example, ocean or seawater can be used as a source of indifferent salts, which can significantly improve the economics of the process under certain conditions. The vast majority of seawater has a salinity of between 31 g/kg and 38 g/kg, that is, 3.1-3.8%. On average, seawater in the world's oceans has a salinity of about 3.5% (35 g/L, 599 mM). Seawater includes a mixture of salts, containing not only sodium chloride as sodium cations and chlorine anions (together totaling about 85% of the dissolved salts present), but also sulfate anions and calcium, potassium and magnesium cations. There are other ions present (such as bicarbonate), but these are the main components. Another natural source of highly soluble salts that can be used as a source of highly soluble salts includes a hypersaline body of water, e.g., a hypersaline lake, pond, or reservoir. A hypersaline body of water is a body of water that has a high concentration of sodium chloride and other highly soluble salts with saline levels surpassing ocean water, e.g., greater than 3.8 wt % and typically greater than about 10 wt %. Such hypersaline bodies of water are located on the surface of the earth and also subsurface, which can be brought to the surface as a result of ore mining operations.

In other embodiments of the present processes, it can be advantageous to use a brine produced in desalinization of salt water as a source of an indifferent salt(s). The brine can be used alone as a source of the indifferent salt(s) or in combination with another source of indifferent salt(s) such as seawater.

Although indifferent salts can destabilize and consolidate solids in feed slurry, adding one or more polymer flocculant(s) can reduced the time for sedimentation and increase overflow output. Hence, one or more polymer flocculants(s) can be added concurrent with or subsequent to treating the feed slurry with the indifferent salt in the thickener apparatus.

Polymers that are useful in practicing the present disclosure include water soluble flocculating polymers such as polyacrylamides or copolymers thereof such as nonionic polyacrylamides and copolymers thereof, an anionic polyacrylamide (APAM) such as a polyacrylamide-co-acrylic acid, and a cationic polyacrylamide (CPAM), which can contain co-monomers such as acryloxyethyltrimethyl ammonium chloride, methacryloxyethyltrimethyl ammonium chloride, dimethyldiallyammonium chloride (DMDAAC), etc. Other water soluble flocculating polymers useful for practicing the present disclosure include a polyamine, such as a polyamine or quaternized form thereof, e.g., polyacrylamide-co-dimethylaminoethylacrylate in quaternized form, a polyethyleneimine, a polydiallyldimethyl ammonium chloride, a polydicyandiamide, or their copolymers, a polyamide-co-amine, polyelectrolytes such as a sulfonated polystyrenes can also be used. Other water soluble polymers such as polyethylene oxide and its copolymers can also be used. The polymer flocculants can be synthesized in the form of a variety of molecular weights (MW), electric charge types and charge density to suit specific requirements. Advantageously, the flocculating polymer used in practicing processes of the present disclosure do not include use of activated polysaccharides or activated starches, i.e., polysaccharides and starches that have been heat treated, in sufficient amounts to lower the density of the floc to below the density of the tailings water from which they are separated. Such activated polysaccharides and activated starches when used in sufficiently high dosages tend to form low density flocs which rise to the surface of an aqueous composition, which can cloud overflow liquid.

The amount of polymer(s) used to treat tailings should preferably be sufficient to flocculate the solids in feed slurry. The amount of polymer(s) used to treat feed slurry can be characterized as a dosage based on the weight percent of the solids in the feed slurry. In some embodiments of the present disclosure, one or more polymer flocculant(s) can be used to treat feed slurry at a dosage (weight of the flocculant(s) to weight of the solids in the slurry) of no less than zero and up to about 0.005 wt %, e.g., up to about 0.01 wt % and in some implementations up to about 0.015 wt %, 0.020 wt %, 0.025 wt %, 0.03 wt %, or 0.04 wt %.

Because indifferent salts and polymer flocculants that are preferably water soluble are used in the process of the present disclosure, the temperature of thickening slurries in a thickener apparatus need not be elevated above ambient temperature to practice the process. In certain embodiments, treating a feed slurry according to the various embodiments herein can be carried out at about ambient temperature or no more about 2 to about 5° C. above ambient temperature.

In practicing aspects of the present process, thickening slurry includes treating a feed slurry with an indifferent salt or solution thereof in a thickener apparatus including a sediment tank and separating and recovering overflow aqueous liquid, e.g. clarified water, from the sediment tank after treating the feed slurry. The process can include combining a feed slurry with a concentration greater than 2 wt % solids, such as greater than 15 wt % and even greater than 20 wt % solids and higher, with an indifferent salt in the tank. With sufficient concentration of the indifferent salt in the aqueous phased of the feed slurry, the solids settle to the bottom of the tank under the pull of gravity and can be pushed towards the outlet port by rakes. Advantageously, the solids loading rate for a feed slurry to be treated with an indifferent salt and optionally polymer flocculant can be greater than 2 (t/h)/m², such at least about 2.5 (t/h)/m² and at least about 3, 3.5, 4, 4.5, 5 and 6 (t/h)/m².

Clarified water can exit the sediment tank through an overflow port or lip of the tank. Conventional overflow clarity is typically in the range of 100 ppm to 5000 ppm. But to achieve such low overflow clarity, the solids loading rate is kept relatively low. An advantage of the present disclosure is that even with a very high solids loading rates (e.g., at least about 4, 5 and 6 (t/h)/m², the overflow clarity remains lower than 5000 ppm, such as lower than 2500 ppm, 1000 ppm and even lower than 500 ppm or 300 ppm. Such overflow clarity can be determined by a turbidity detector.

Settling performance and the final solids content of the settled solids (thickener underflow slurry) is enhanced by treating the slurry with the indifferent salt. An advantage of treating feed slurry with an indifferent salt according to aspects of the present disclosure is that a rise rate of treated feed slurry can be very low even with a high solids loading rate. For example, a rise rate of treated feed slurry can be less than 3 (meter/hour) (m/h) at a solids loading rate (t/h)/m² between about 3-6 and even less than 2 m/h at a solids loading rate about 1.5 (t/h)/m².

Advantageously, since the indifferent salt is highly water soluble salt, the indifferent salt remains almost entirely in the aqueous phase of the treated feed slurry and can be recovered with overflow aqueous liquid, e.g. clarified water, from the sediment tank after treating the feed slurry. In certain embodiments of the present disclosure, the overflow liquid, e.g. clarified water, recovered from the treated feed slurry has a concentration of the indifferent salt that is similar to the concentration of the indifferent salt in the treated feed slurry. Some loss of indifferent salt may be due to loss with removing underflow slurry. However, it is preferable that the directly recovered overflow aqueous liquid has a concentration of the indifferent salt dissolved therein of at least about 0.3 wt %, such as at least 0.4 wt %, 0.5 wt % and preferably no less than about 0.70 wt %, such as at least about 1 wt %, etc. The separated overflow liquid including the dissolved indifferent salt can be used to treat additional tailings in the thickener apparatus. In addition, the separated overflow liquid including the dissolved indifferent salt can be concentrated prior to use to treat additional feed slurry such as by reverse osmosis.

### EXAMPLES

The following examples are intended to further illustrate certain preferred embodiments of the invention and are not limiting in nature. Those skilled in the art will recognize, or be able to ascertain, using no more than routine experimentation, numerous equivalents to the specific substances and procedures described herein.

Copper tailings were blended to yield an average solids concentration of about 30% by mass and then split into two feed slurry samples. One sample was treated with a polyacrylamide flocculant AF 304 (reference sample) and another same was treated with a solution of an indifferent salt (ammonium sulfate) and polymer flocculant (test sample). Both samples showed consolidation of solids. However, the reference sample needed to be diluted for effective flocculation whereas the test sample did not require dilution for effective flocculation and could be flocculated with a solids concentration of 34 wt. %. Further dynamic high-rate batch thickening testwork showed that the test sample could be consolidated at much higher thickener feed solids concentrations than is customary with conventional flocculants. It was found that less energy was required to achieve the flocculation and that the resulting floccules are more stable.

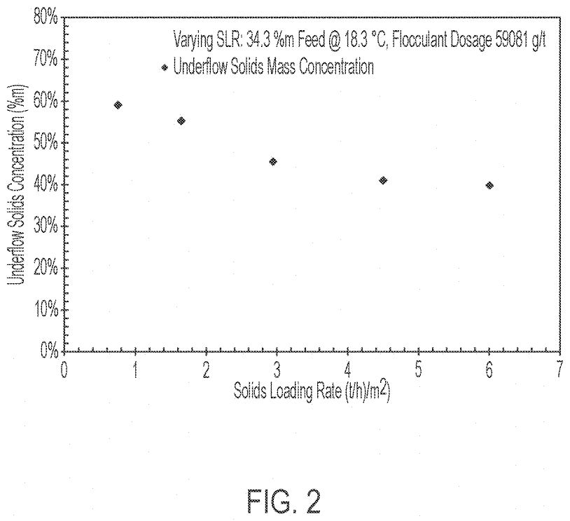

FIG. 2 is a plot of underflow solids concentration as function of solids loading rate for test samples (i.e., treated feed slurry with a solution of an indifferent salt (ammonium sulfate and polymer flocculant). As shown by the plot of FIG. 2, underflow solids concentration drops with increasing solids loading rate. However, the data shows that treated feed slurry with the indifferent salt resulted in much higher solids loading rates compared to a conventional high-rate thickening.

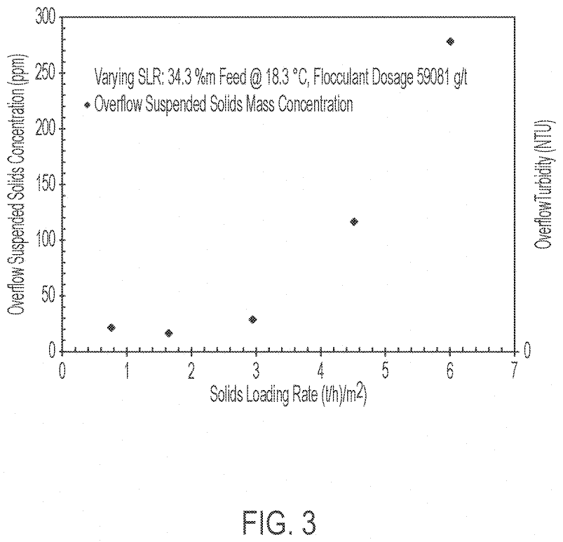

FIG. 3 is a plot of overflow solids concentration as a function of solids loading rate for the treated test sample. FIG. 3 shows that even with very high solids loading rates (e.g., 6 (t/h)/m², the overflow clarity remains lower than 300 ppm, and well within conventional overflow clarity of 100 ppm to 5000 ppm of conventional thickeners. Solids carry-over is mostly in the form of very fine floccules, which can be mostly captured in the bottoms of subsequent surge tanks.

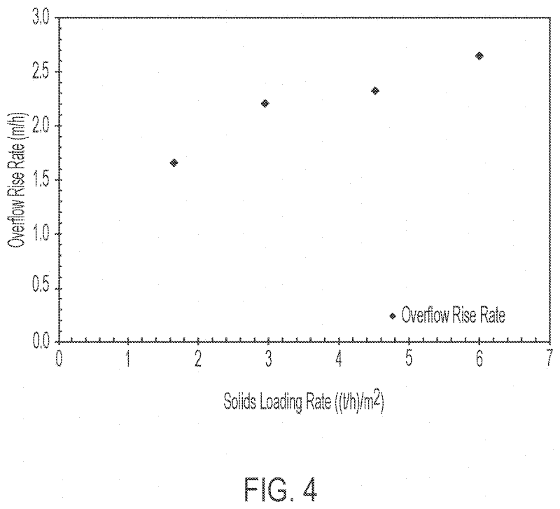

FIG. 4 is a plot of overflow rise rate as a function of solids loading rate for the treated test sample. FIG. 4 provides an explanation for the exceptional overflow clarities obtained with treating the test sample feed slurry with an indifferent salt, namely a much reduced rise rate in the thickener as feed to the thickener even with an undiluted feed slurry. As shown in FIG. 4, the rise rate of treated feed slurry have the following values:

| Rise rate (m/h) | Solids loading rate (t/h)/m² |
|---|---|
| <3 | 6 |
| <2.5 | 4.5 |
| <2.5 | 3 |
| <2 | 1.5 |

The reduced rise rate observed for the treated slurry improved overflow clarity. The data also show that treating a slurry feed with an indifferent salt and polymer flocculant can be carried out on an undiluted slurry stream, i.e., a slurry feed stream with a solids concentration of over 15% mass, such as over 30% mass. Another benefit of flocculation at the higher solids concentration is that dilution at or before the feedwell is not required which reduces complexity and feedwell size requirements.

In addition, the effective flocculation with an indifferent salt makes possible very high thickener feed solids loading rates. While the underflow solids concentration decreases with solids loading rate, the consolidation testwork has shown that the high consolidation rate achieved when treating with the indifferent salt makes it possible to maintain the underflow solids concentrations through increased bed retention time achieved through increased thickener sidewall heights as is the case with high-density or paste thickeners. Treating a slurry feed with an indifferent salt and flocculant therefore means that smaller diameter but taller thickeners can be used, or conversely that less thickeners are required for an application.

Overall, it was concluded that thickening a feed slurry with an indifferent salt and polymer flocculant was highly effective, requiring significantly less energy and time when compared to conventional flocculation chemistry. In addition, thickening efficiency was found to be much less sensitive to minerology and effectively dewaters clay-rich samples.

Phosphate tailings slimes were treated with an indifferent salt to determine thickening impact of treated slimes compared to untreated slimes. For the same thickener underflow solids mass concentration (%), slimes treated with an indifferent salt had about a 10 times increase in thickener solids loading rate (t/h)m². The 10 fold increase in in thickener solids loading rate occurred over a thickener underflow solids mass concentration (%) range of about 41% to about 50%. Further the treated slimes could achieve a thickener underflow solids mass concentration (%) of up to 55% whereas the untreated slimes achieved a thickener underflow solids mass concentration (%) of less than 50%.

Only the preferred embodiment of the present invention and examples of its versatility are shown and described in the present disclosure. It is to be understood that the present invention is capable of use in various other combinations and environments and is capable of changes or modifications within the scope of the inventive concept as expressed herein. Thus, for example, those skilled in the art will recognize, or be able to ascertain, using no more than routine experimentation, numerous equivalents to the specific substances, procedures and arrangements described herein. Such equivalents are considered to be within the scope of this invention, and are covered by the following claims.

1. A process of thickening a slurry, the process comprising treating a feed slurry in a thickener apparatus with an indifferent salt to separate the feed slurry into an underflow slurry and an overflow liquid with an increase efficiency of at least 10% as compared to the feed slurry in the thickener apparatus without the added indifferent salt.

2. The process of claim 1, wherein the thickener apparatus includes a feed system fluidly connected to a thickener tank wherein the tank has an exit port for underflow slurry and port or lip for overflow liquid.

3. The process of claim 1, wherein the treated feed slurry has a concentration of the indifferent salt dissolved in an aqueous phase thereof of at least 0.5 wt %.

4. The process of claim 1, further comprising treating the feed slurry with at least one polymer flocculant concurrent with or subsequent to treating the feed slurry with the indifferent salt.

5. The process of claim 1, further comprising recovering the overflow liquid which includes the indifferent salt dissolved therein and concentrating the indifferent salt in the overflow liquid and combining the concentrated indifferent salt with additional feed slurry.

6. The process of claim 5, wherein the indifferent salt is an alkali halide.

7. The process of claim 5, wherein the indifferent salt is an ammonium based salt that does not include multivalent cations.

8. The process of claim 5, wherein the directly recovered overflow liquid includes the indifferent salt dissolved therein at a concentration of at least 0.3 wt %.
